(19) United States
(12) Patent Application Publication
(10) Pub. No.: US 2008/0133606 A1
(43) Pub. Date: Jun. 5, 2008

(54) METHOD AND SUBSCRIBER DEVICE FOR IMPLEMENTING NSP SELECTION

(75) Inventors: Shujun DANG, Guangdong Province (CN); Peng Zhang, Guangdong Province (CN)

Correspondence Address: LADAS & PARRY, 5670 WILSHIRE BOULEVARD, SUITE 2100, LOS ANGELES, CA, 90036-5679, US

(73) Assignee: HUAWEI TECHNOLOGIES CO., LTD., Guangdong Provice (CN)

(21) Appl. No.: 11/963,113

(22) Filed: Dec. 21, 2007

Related U.S. Application Data
(63) Continuation of application No. PCT/CN2006/001450, filed on Jun. 26, 2006.

(30) Foreign Application Priority Data
Jun. 29, 2005 (CN) 200510035484.4

(51) Int. Cl. G06F 15/16; G06F 17/30

(52) U.S. Cl. 707/104.1; 709/227; 707/E17.044

(57) ABSTRACT

A method and a subscriber device for implementing an NSP selection. The method includes: when a subscriber device accesses a network, obtaining information of an NAP accessible at current location; when the subscriber device stores the information of NSPs accessible for the NAP, obtaining the information of NSPs accessible for the NAP; otherwise, receiving the information of NSPs accessible for the NAP from the network side; adding the information of accessible NSPs to the information of available NSPs; and selecting an NSP from the available NSPs for a service of the subscriber device. Therefore, extra occupation on air interface resources is lowered, and the time consumption during the network discovering and selecting process is effectively lowered.

The present application is a continuation of PCT application PCT/CN2006/001450, filed on Jun. 26, 2006, entitled “AN IMPLEMENTING METHOD AND USER EQUIPMENT FOR SELECTING NETWORK SERVICE PROVIDER”, which is incorporated by reference herein in its entirety.

### FIELD OF THE INVENTION

The present invention relates to access technologies in wireless communication networks, in particular, to a method and a subscriber device for implementing a Network Service Provider (NSP) selection during an accessing process in a wireless communication network.

### BACKGROUND OF THE INVENTION

With the development of wireless communication technologies, wireless communication networks appear continuously in new forms, such as ever-developing Worldwide Interoperability for Microwave Access (WiMax) Forum network and Wireless Local Area Network (WLAN). Usually, the wireless communication network includes subscriber devices, Network Access Providers (NAPs) and NSPs operated by different operators. For example, for the WiMax network, a WiMax network based on IEEE 802.16 standard may provide a higher access rate. FIG. 1 is a schematic diagram of a WiMax network reference model in a non-roaming state, and FIG. 2 is a schematic diagram of a WiMax network reference model in a roaming state.

Referring to FIG. 1, in the non-roaming state, Access Service Network (ASN) 110 is connected with Connection Service Network (CSN) 120, and Subscriber Station/Mobile Subscriber Station (SS/MSS) 130 accesses the core network CSN 120 via access network ASN 110. Referring to FIG. 2, in the roaming state, ASN 110 is connected with Visited CSN 121, Visited CSN 121 is connected with Home CSN 122, and SS/MSS 130 implements an authentication and verification via ASN 110 and Visited CSN 121 and enjoys services provided by Visited CSN 121 and Home CSN 122.

Generally, ASN is operated by an NAP, and CSN is operated by an NSP. In practice, NAP, Visited NSP and Home NSP may be different operators; and a plurality of ASNs may cover the same place, and each ASN may be connected with a plurality of NSP networks. There are two different collocated modes in WiMax network. One is NAP+NSP mode, i.e. NAP and NSP have a one-to-one correspondence; and the other is ASN Shared mode, i.e. an ASN has a roaming protocol with a plurality of NSPs, and is shared by a plurality of NSPs.

A possible collocated mode in WiMax network is shown in FIG. 3.

An area is covered by both NAP 4 and NAP 6, and CSN 1201, 1202, 1203 of different NSPs share NAP 4; NAP 6 is bound to CSN 1204; and SS/MSS 131, 132 access the network via ASN 111, 112 respectively.

In ASN Shared mode, the subscriber device will be confronted with a problem on how to know which NSPs share the current ASN, i.e. how to know which NSPs are available via the current ASN. This is the problem of NSP selection, which appears in the wireless communication network, i.e. how does the network provide the information of the currently available networks to the subscriber device. Therefore, the subscriber device selects an NSP from all accessible NSPs at current location to access the network.

At present, there are two methods for implementing the NSP selection in a wireless communication network.

One method is implemented by configuring a broadcast message. For example, as specified in IEEE802.16 protocol, by adding a broadcast message Service-Identity-Information, a Base Station (BS) may initiatively broadcast the information of accessible NSPs periodically by using the broadcast message, or broadcast corresponding NSP information when the SS/MSS requests. The information elements contained in the message are as shown in Table 1:

TABLE 1

| Symbol | Size | Note |
|---|---|---|
| Service-Identity-Information format ( ) { | | |
| Management Message Type = To Be | 8 bits | |
| Assigned | | |
| TLV encoded Information | Variables | TLV specifics |
| | | (See Table 2) |

The TLV contained in the above broadcast message at least includes one NSP ID, and the NSP ID is defined in the TLV mode shown in Table 2:

TABLE 2

| Type | Length | Value |
|---|---|---|
| To-Be-Assigned | To-Be-Defined | NSP identity |

According to the solution, when the SS/MSS receives a broadcast message from the BS, the SS/MSS receives the NSP information carried in the message sent by the BS periodically. If the waiting time is too long, the SS/MSS may also carry the message elements shown in Table 3 in an RNG-REQ message so as to initiatively request the BS to send a related broadcast message.

TABLE 3

| Type | Length | Value |
|---|---|---|
| To-Be-Assigned | 1 | NULL |
| | | character |

If the RNG-REQ message carries the above message elements, it is indicated that the SS/MSS requests the BS to send the NSP list information for NSPs supported by the BS; otherwise, no requirement is laid.

The above method for implementing the NSP selection by delivering NSP information via a broadcast message has the following problems.

1. The time delay is too long. Because it takes a period to broadcast the NSP list, the SS/MSS needs to wait for a period of time before receiving related broadcast information.

2. Downlink air interface resources are wasted. If a small period is employed to send the related broadcast message, more air interface resources are needed to send the related message.

3. Uplink air interface resources are wasted. If the SS/MSS requests to send the related broadcast message, random access resources are occupied.

In another method for implementing the NSP selection, the NSP list of NSPs supported by the network may be carried via an Extensible Authentication Protocol (EAP) ID request message, and an Authentication, Authorization and Accounting (AAA) verification process corresponding to the method is as shown in FIG. 4. Specifically, the verification process includes the following steps.

1. An SS/MSS performs a random access, and performs a basic capability exchange.

2. The SS/MSS requests to start an EAP process.

3. A BS sends the EAP ID request message, which carries the NSP list information of NSPs supported by the BS, to the SS/MSS.

4. The SS/MSS sends an EAP ID response message according to the information obtained, and performs an initial authentication and verification process.

In step 3, the BS will send the NSP list of NSPs supported by the NAP to the subscriber device, and the subscriber device will implement the NSP selection according to the NSP list.

However, the problem that air interface resources are wasted still exists. Because information interaction between the SS/MSS and the network side is needed, according to the method, the uplink and downlink air interface resources are occupied, and the processing load on the network side is increased.

### SUMMARY OF THE INVENTION

The present invention provides a method and a subscriber device for implementing an NSP selection, so that extra occupation of air interface resources during the network accessing process and time consumption during the NSP discovering and selecting process may be reduced.

According to an aspect of the present invention, a method for implementing an NSP selection includes:

when a subscriber device accesses a network, obtaining information of an NAP accessible at current location;

when the subscriber device stores the information of NSPs accessible for the NAP, obtaining stored information of the NSPs accessible for the NAP; when the subscriber device does not store the information of the NSPs accessible for the NAP, receiving the information of the NSPs accessible for the NAP from the network side;

adding information of an accessible NSP into the information of available NSPs; and

selecting an NSP for a service of the subscriber device from the available NSPs.

Optionally, the method further includes: storing the information of the NSPs accessible for the NAP obtained from the network side.

Optionally, obtaining the information of the NSPs accessible for the NAP from the network side includes: receiving the information of the NSPs carried in a message from a BS.

Optionally, obtaining the information of the NSPs accessible for the NAP from the network side includes: initiatively requesting a BS to send a message carrying the information of the NSPs accessible for the NAP, and obtaining the information of the NSPs accessible for the NAP carried in the message after the message is received.

Optionally, obtaining the information of the NSPs accessible for the NAP from the network side includes: receiving the information of the NAPs carried in an EAP message from the BS.

Optionally, the method further includes:

determining whether a Home NSP of the subscriber device is included in the obtained NSPs accessible for the NAP; when the Home NSP of the subscriber device is comprised in the obtained NSPs accessible for the NAP, taking the Home NSP as the NSP for a service of the subscriber device.

The subscriber device may be an MSS or an SS.

According to another aspect of the present invention, a subscriber device includes:

a storage unit, adapted to store information of NSPs accessible for at least one NAP;

an NAP information obtaining unit, adapted to obtain information of the NAP accessible at current location during a network accessing process;

an NSP information obtaining unit, adapted to obtain stored information of the NSPs accessible for the NAP when the information of the NSPs accessible for the NAP is stored on the subscriber device, and receive the information of NSPs accessible for the NAP from the network side when the subscriber device does not store the information of the NSP accessible for the NAP; and

an NSP selecting unit, adapted to add the information of an accessible NSP into information of available NSPs and select an NSP for a service of the subscriber device from the available NSPs.

Optionally, when a Home NSP of the subscriber device is included in obtained NSPs accessible for the NAP, the NSP selecting unit takes the Home NSP as the NSP for a service of the subscriber device.

Compared with the prior art, the present invention has the following advantages.

In the present invention, by configuring and storing the information of NSPs accessible for the NAP in a subscriber device, when the subscriber device accesses a network, if the information of NSPs accessible for the NAP at current location of the subscriber device is stored, stored information of NSPs may be taken as the information of available NSPs. Only when the information of NSPs is not stored, the information of NSPs accessible for the NAP at the current location of the subscriber device is obtained from the network side. Therefore, the extra occupation on air interface resources for obtaining the NSPs information from the network side may be lowered. On the other hand, the time consumption during the network discovering and selecting process may also be effectively lowered.

### BRIEF DESCRIPTION OF THE DRAWINGS

FIG. 1 is a schematic diagram of a WiMax network reference model in a non-roaming state of the prior art;

FIG. 2 is a schematic diagram of a WiMax network reference model in a roaming state of the prior art;

FIG. 3 is a WiMax network disposition mode of the prior art;

FIG. 4 is a flow chart of the process for delivering NSP list information via an EAP message in the prior art;

FIG. 5 is a flow chart of the process for implementing the NSP selection according to the present invention;

FIG. 6 is a flow chart of the first embodiment of the present invention; and

FIG. 7 is a flow chart of the second embodiment of the present invention.

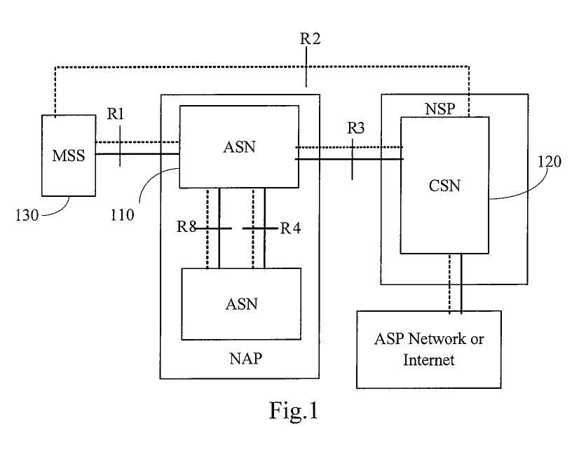

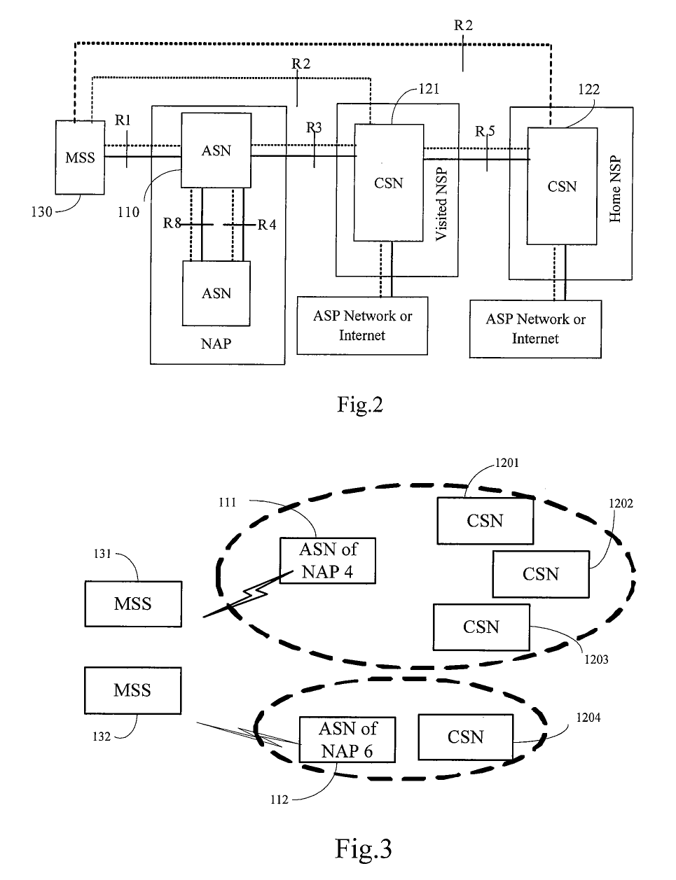

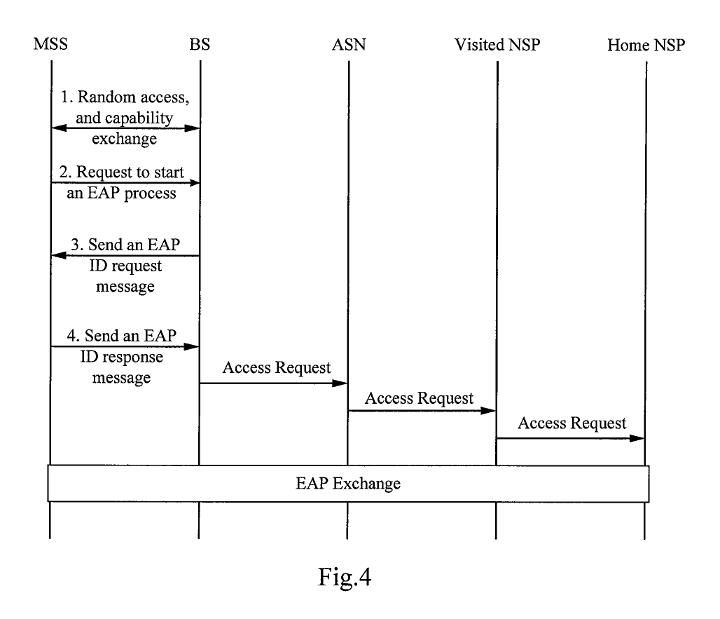

### DETAILED DESCRIPTION OF THE EMBODIMENTS

In the present invention, the subscriber device is usually an MSS or an SS.

Usually, the subscriber device needs to select a suitable network to access. This process includes four phases.

Discovery Phase of NAP: The SS/MSS discovers all accessible NAP networks at current location (i.e. the coverage area of the NAP network includes the current location of the SS/MSS).

Discovery Phase of NSP List: For each accessible NAP network, at least one corresponding NSP is discovered.

Obtaining and Selecting Phase: All NSPs accessible for the SS/MSS at current location are listed, and a list is formed, then a suitable NSP is selected from the list according to a certain rule.

Network Access Phase According To Selected NSP: A suitable NAP is selected according to the selected NSP (if an NSP may be accessed via two or more NAPs), and an initial accessing process is performed.

The improvement of the present invention mainly relates to the above Discovery Phase of NAP and Discovery Phase of NSP List.

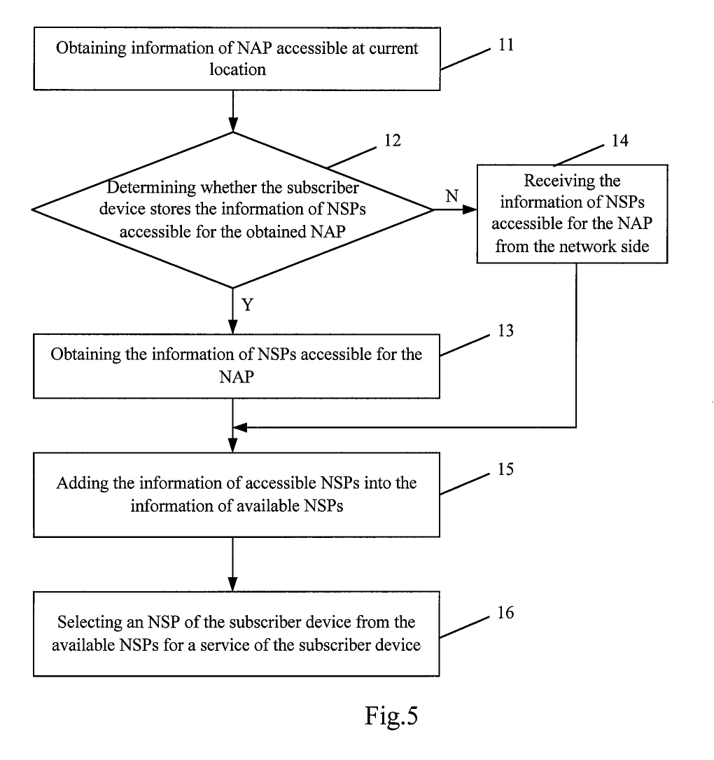

FIG. 5 shows a flow chart of the method for implementing the NSP selection according to the present invention. In the present invention, the information of NSPs accessible for NAPs is preconfigured and stored in a subscriber device. When the subscriber device accesses the network, the process for implementing the NSP selection mainly includes the following steps.

Step 11: The information of accessible NAPs at current location is obtained.

Step 12: It is determined whether the subscriber device stores the information of NSPs accessible for an obtained NAP, and if yes, the flow turns to Step 13; otherwise, the flow turns to Step 14.

Step 13: The stored information of NSPs accessible for the NAP is obtained, and then the flow turns to Step 15.

Step 14: The obtained information of NSPs accessible for the NAP is received from the network side. Specifically, in order to implement the dynamic update of NAP/NSP configuration information of the subscriber device, the present invention may also store the information of NSPs accessible for the NAP which is obtained from the network side as the information of NSPs accessible for the NAP; and then the process flow turns to Step 15.

Additionally, in the present invention, various modes may be employed to obtain the information of NSPs accessible for the NAP from the network side. For example, the information of NSPs accessible for the NAP may be obtained by receiving the information of the NSP carried in a broadcast message from a BS, or the subscriber device may initiatively request the BS to send a broadcast message including the information of NSPs accessible for the NAP, and the information of NSPs accessible for the NAP carried in the broadcast message is obtained after the broadcast message is received. Optionally, the information of NSPs accessible for the NAP may be obtained by receiving the information of the NSP carried in an EAP message from the BS. The above modes are disclosed in the prior art, and a detailed description thereof is omitted.

Step 15: The information of NSPs accessible for the NAP is added to the information of available NSPs.

Step 16: An NSP is selected from the available NSPs for the subscriber device.

Now, the present invention will be described with respect to specific embodiments.

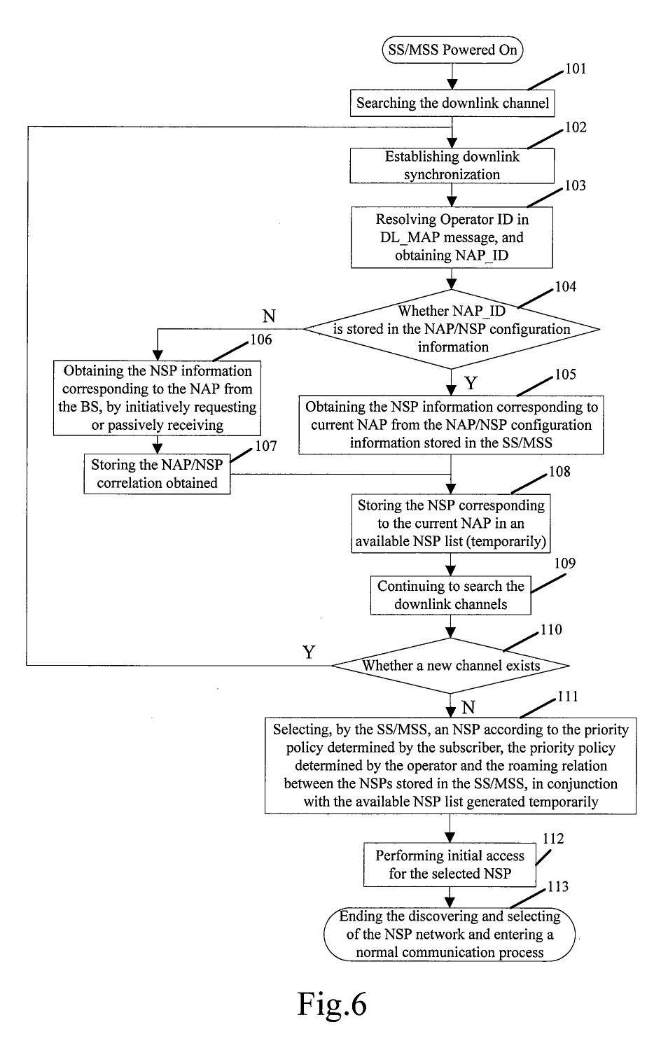

FIG. 6 shows a flow chart of the first preferred embodiment of the present invention.

In this embodiment, the information of NSPs accessible for the NAPs is stored in the SS/MSS in the form of the NAP/NSP configuration information. Specifically, the NSP selection mainly includes the following steps.

Step 101 and Step 102: The downlink channels are searched and the downlink synchronization is established.

Step 103: A DL_MAP message is received, and NAP_ID information may be obtained from the “Operator ID”.

Step 104: It is determined whether NAP_ID is saved in the NAP/NSP configuration information stored in an SS/MSS, if yes, the flow turns to Step 105; otherwise, the flow turns to Step 106.

Step 105: The NSP information corresponding to the current NAP is extracted from the NAP/NSP configuration information stored in the SS/MSS (and, it is not necessary to further receive the NAP/NSP configuration information in the broadcast information or initiatively query the NAP/NSP configuration information), and then the flow turns to Step 108.

Step 106: The NAP/NSP configuration information is further received from the broadcast information, or the NAP/NSP configuration information is actively queried.

Step 107: The obtained NAP/NSP configuration information is stored into the NAP/NSP configuration information.

Step 108: The NSPs accessible for the current NAP is stored into an available NSP list (temporarily).

Step 109 and Step 110: The downlink channels are searched continually, if a new channel is found, the flow returns to Step 102; otherwise, the flow turns to Step 111.

Step 111: The SS/MSS selects an NSP as the NSP of the current service according to the priority policy determined by the operator, the roaming relation between the NSPs and the priority policy determined by the subscriber in the SS/MSS, in conjunction with the available NSP list generated temporarily.

Step 112: An initial access (including the authentication and verification process) is performed for the selected NSP

Step 113: The discovering and selecting for the NSP network ends, and a normal communication process is proceeded.

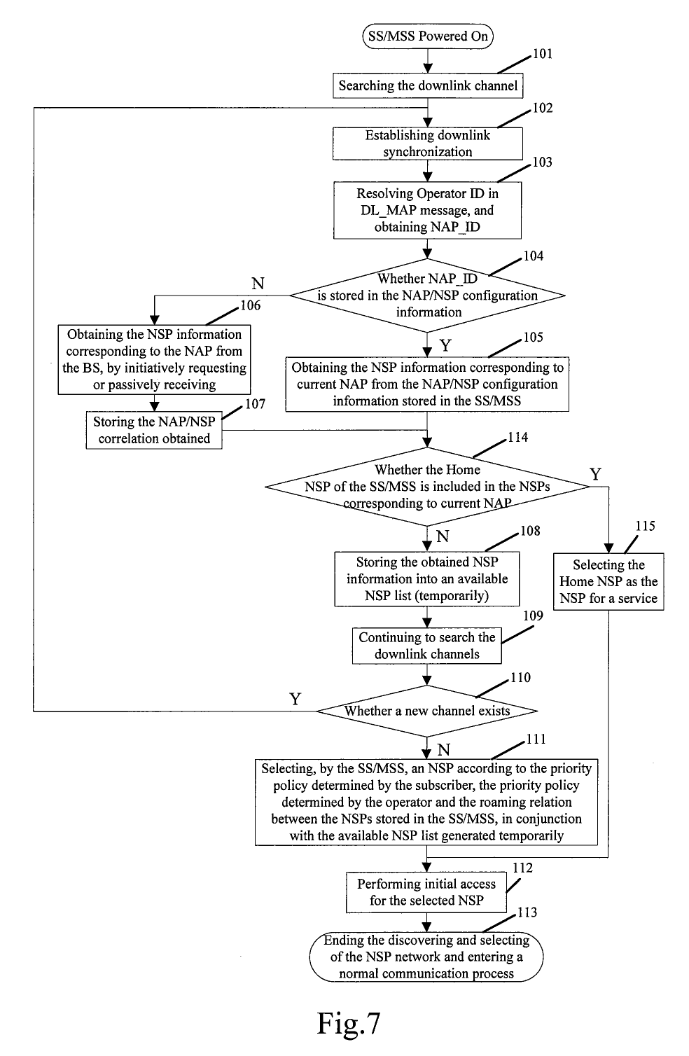

FIG. 7 shows a flow chart of the second preferred embodiment of the present invention.

To embody the concept of Home NSP accessed First, the process of the first embodiment is optimized, and two optional steps including Step 114 and Step 115 are added. Specifically, in Step 114, it is determined whether the Home NSP of the subscriber device is included in the obtained NSPs accessible for current NAP, if yes, the flow turns to Step 115. In Step 115, the Home NSP is selected as the NSP for the service of the subscriber device, and then the flow turns to Step 112, i.e. when the SS/MSS discovers that the Home NSP may be accessed via current NAP, the SS/MSS performs an initial network accessing process and does not continue to perform the subsequent network discovering and selecting process.

The present invention provides a subscriber device, including:

a storage unit, adapted to store information of an NSP accessible for an NAP;

an NAP information obtaining unit, adapted to obtain information of the NAP accessible at current location during a network accessing process;

an NSP information obtaining unit, adapted to obtain stored information of the NSP accessible for the NAP when the subscriber device stores the information of the NSP accessible for the NAP, and receive the information of NSP accessible for the NAP from the network side when the subscriber device does not store the information of the NSP accessible for the NAP; and

an NSP selecting unit, adapted to add the information of an accessible NSP into information of available NSPs and select an NSP for a service of the subscriber device from the available NSPs.

To embody the concept of Home NSP accessed First, when the Home NSP of the subscriber device is included in the obtained NSPs accessible for the NAP, the NSP selecting unit may take the Home NSP as the NSP for the service of the subscriber device.

Additional advantages and modifications will readily occur to those skilled in the art. Therefore, the present invention in its broader aspects is not limited to the specific details and representative embodiments shown and described herein. Accordingly, various modifications and variations may be made without departing from the spirit or scope of the present invention as defined by the appended claims and their equivalents.

1. A method for implementing a Network Service Provider, NSP, selection, comprising:
when a subscriber device accesses a network, obtaining information of at least one Network Access Provider, NAP, accessible at current location;
when the subscriber device stores information of NSPs accessible for the NAP, obtaining stored information of the NSPs accessible for the NAP; when the subscriber device does not store the information of the NSPs accessible for the NAP, receiving the information of the NSPs accessible for the NAP from the network side;
adding information of an accessible NSP into information of available NSPs; and
selecting an NSP for a service of the subscriber device from the available NSPs.

2. The method for implementing the NSP selection according to claim 1, further comprises: storing the information of the NSPs accessible for the NAP obtained from the network side.

3. The method for implementing the NSP selection according to claim 1, wherein, obtaining the information of the NSPs accessible for the NAP from the network side comprises: receiving the information of the NSPs carried in a message from a base station, BS.

4. The method for implementing the NSP selection according to claim 1, wherein, obtaining the information of the NSPs accessible for the NAP from the network side comprises: requesting a BS to send a message carrying the information of the NSPs accessible for the NAP, and obtaining the information of the NSPs accessible for the NAP carried in the message after the message is received.

5. The method for implementing the NSP selection according to claim 1, wherein, obtaining the information of the NSPs accessible for the NAP from the network side comprises: receiving the information of the NSPs carried in an EAP message from a BS.

6. The method for implementing the NSP selection according to claim 1, further comprises:
when a Home NSP of the subscriber device is comprised in obtained NSPs accessible for the NAP, taking the Home NSP as the NSP for the service of the subscriber device.

7. The method for implementing the NSP selection according to any of claim 1, wherein, the subscriber device is an MSS, Mobile Subscriber Station, or an SS, Subscriber Station.

8. The method for implementing the NSP selection according to claim 2 further comprises adding the information of the NSPs accessible for the NAP obtained from the network side into information of available NSPs.

9. The method for implementing the NSP selection according to claim 1 wherein information of available NSPs is an available NSP list.

10. The method for implementing the NSP selection according to claim 8 wherein information of available NSPs is an available NSP list.

11. A subscriber device, comprising:
a storage unit, adapted to store information of Network Service Providers, NSPs, accessible for a Network Access Provider, NAP_{—}
an NAP information obtaining unit, adapted to obtain information of the NAP accessible at current location during a network accessing process;
an NSP information obtaining unit, adapted to obtain stored information of NSPs accessible for the NAP when the information of the NSPs accessible for the NAP is stored on the subscriber device, and receive the information of the NSPs accessible for the NAP from the network side when the subscriber device does not store the information of the NSPs accessible for the NAP; and
an NSP selecting unit, adapted to add information of an accessible NSP into information of available NSPs and select an NSP for a service of the subscriber device from the available NSPs.

12. The subscriber device according to claim 11 further comprises: the storage unit adapted to store the information of the NSPs accessible for the NAP from the network side.

13. The subscriber device according to claim 12 wherein the information of the NSPs stored in the storage unit is an available NSP list.

14. The subscriber device according to claim 1, wherein, when a Home NSP of the subscriber device is comprised in obtained NSPs accessible for the NAP, the NSP selecting unit takes the Home NSP as the NSP for the service of the subscriber device.

15. A method for implementing a Network Service Provider, NSP, selection, comprising
when a subscriber device accesses a network, obtaining information of at least one Network Access Provider, NAP, accessible at current location;
determining whether the subscriber device stores information of NSPs supported by the NAP, if the information is stored, obtaining stored information of the NSPs supported by the NAP; if the information is not stored, receiving the information of the NSPs supported by the NAP from the network side;
selecting an NSP for a service of the subscriber device from an available NSP list.

16. The method for implementing the NSP selection according to claim 15, further comprises: storing the information of the NSPs supported by the NAP obtained from the network side into the available NSP list.

17. The method for implementing the NSP selection according to claim 15, further comprises: adding the information for obtaining stored information of the NSPs supported by the NAP into the available NSP list.

18. The method for implementing the NSP selection according to claim 15, further comprises:
when a Home NSP of the subscriber device is comprised in the available NSP list, taking the Home NSP as the NSP for the service of the subscriber device.
